(19) United States
(12) Patent Application Publication
(10) Pub. No.: US 2022/0352507 A1
(43) Pub. Date: Nov. 3, 2022

(54) METHOD AND APPARATUS FOR FABRICATING AN ELECTRODE FOR A BATTERY

(71) Applicant: GM GLOBAL TECHNOLOGY OPERATIONS LLC, Detroit, MI (US)

(72) Inventors: Brian J. Koch, Berkley, MI (US); Jing Gao, Rochester, MI (US); Zhe Li, Rochester, MI (US); Yucong Wang, West Bloomfield, MI (US)

(73) Assignee: GM GLOBAL TECHNOLOGY OPERATIONS LLC, Detroit, MI (US)

(21) Appl. No.: 17/244,196

(22) Filed: Apr. 29, 2021

(51) Int. Cl. H01M 4/38; H01M 4/583; H01M 4/62; H01M 4/46; H01M 4/66; H01M 4/70

(52) U.S. Cl. CPC H01M 4/382; H01M 4/583; H01M 4/622; H01M 4/463; H01M 4/662; H01M 4/70

(57) ABSTRACT

A reference electrode for a lithium-ion battery cell in the form of a porous ultrathin film that is fabricated from aluminum or an aluminum alloy is described. The aluminum layer is conductive and functions as a current collector for the reference electrode. The alloying elements may include but not limited to one or more of copper, zinc, silver, gold, titanium, chrome, rare earth metals, etc., to achieve target values for electrical, mechanical and chemical properties. Also disclosed is an electrochemical battery cell having an anode, a cathode, and a reference electrode, wherein the reference electrode is interposed between the anode and the cathode, wherein the reference electrode is an electrode layer that is arranged on a current collector, and wherein the current collector is fabricated from an aluminum alloy.

### INTRODUCTION

Lithium ion battery packs may include one or multiple lithium ion battery cells that are electrically connected in parallel or in series, depending upon the needs of the system. Each battery cell includes one or a plurality of lithium ion electrode pairs that are enclosed within a sealed pouch envelope. In some embodiments, each electrode pair includes a negative electrode (anode), a positive electrode (cathode), and a reference electrode, with separators arranged therebetween. The separators function to physically separate and electrically isolate the negative and positive electrodes from the reference electrode.

To facilitate lithium ion mobility, an electrolyte that conducts lithium ions may be present within the separators. The electrolyte allows lithium ions to pass through the separators between the positive and negative electrodes through the reference electrode to counterbalance the flow of electrons that, during charge and discharge cycles of the lithium ion battery cell, circumvent the separator and move between the electrodes through an external circuit. Depending on their chemistry, each lithium ion battery cell has a maximum or charging voltage (voltage at full charge) due to the difference in electrochemical potentials of the electrodes. For example, each lithium ion battery cell may have a charging voltage in the range of 3V to 5V and a nominal open circuit voltage in the range of 2.9V to 4.2V.

Each battery cell is configured to electrochemically store and release electric power. Each negative electrode has a current collector with a negative foil that is coupled to a negative terminal tab, and each positive electrode has a current collector with a positive foil that is coupled to a positive terminal tab. Within each battery cell, the negative terminal tab electrically communicates with the negative current collectors that contact and exchange electrons with the negative electrodes of the electrode pairs, and the positive terminal tab electrically communicates with the positive current collectors that contact and exchange electrons with the positive electrodes of the electrode pairs. Lithium-ion battery cells are capable of being discharged and re-charged over many cycles. There are benefits to having an improved reference electrode in a battery cell.

### SUMMARY

The concepts herein provide for a reference electrode for a lithium-ion battery cell that is a porous ultrathin film that is fabricated from aluminum or an aluminum alloy. The aluminum layer is conductive and functions as a current collector for the reference electrode. The alloying elements may include but not limited to one or more of copper, zinc, silver, gold, titanium, magnesium, silicon, manganese, cobalt, iron, chrome, rare earth etc. to achieve target values for electrical, mechanical and chemical properties.

An aspect of the disclosure includes an electrochemical battery cell having an anode, a cathode, and a reference electrode, wherein the reference electrode is interposed between the anode and the cathode, and wherein the reference electrode is an electrode layer that is arranged on a current collector. The electrode layer has an electrochemically active lithium compound, a conductive carbon additive, and a polymeric binder that are arranged on a current collector. The current collector is fabricated from an aluminum alloy.

Another aspect of the disclosure includes a first separator interposed between the anode and the reference electrode, and a second separator interposed between the reference electrode and the cathode.

Another aspect of the disclosure includes the reference electrode being a ultrathin film electrode layer that is arranged on the current collector.

Another aspect of the disclosure includes the first separator, the reference electrode, and the second separator being fabricated as a single element that is interposed between the anode and the cathode.

Another aspect of the disclosure includes the current collector for the reference electrode having a thickness that is less than 200 microns (um), and is a thickness that is between 5 microns (um) and 50 um in some embodiments.

Another aspect of the disclosure includes the current collector being fabricated from an aluminum alloy having a porosity that is in a range between 30% and 60%.

Another aspect of the disclosure includes the current collector being fabricated from an aluminum alloy having a porosity that is in a range between 20% and 80%.

Another aspect of the disclosure includes the current collector being fabricated from aluminum.

Another aspect of the disclosure includes the current collector being fabricated from an aluminum alloy having an aluminum content that is greater than 90%.

Another aspect of the disclosure includes the current collector being fabricated from an aluminum alloy having an aluminum content that is greater than 90%, and an alloy comprising one of copper, zinc, silver, gold, titanium, magnesium, silicon, manganese, cobalt, iron, or chrome.

Another aspect of the disclosure includes the current collector having a modulus of elasticity that is within a range of 20 to 200 gigapascals (GPa).

Another aspect of the disclosure includes the aluminum alloy for the current collector having a modulus of elasticity that is within a range of 20 to 200 GPa.

Another aspect of the disclosure includes the current collector being arranged as a rectangular planar sheet.

Another aspect of the disclosure includes the current collector being arranged as a circular planar sheet.

Another aspect of the disclosure includes the current collector being arranged as a cylindrical sheet.

Another aspect of the disclosure includes the current collector being fabricated from an aluminum alloy having an aluminum content that is greater than 90%.

Another aspect of the disclosure includes an electrochemical battery cell that includes an anode, a cathode, a reference electrode, a first separator, and a second separator, wherein the reference electrode is interposed between the anode and the cathode, wherein the first separator is interposed between the anode and the reference electrode, wherein the second separator is interposed between the reference electrode and the cathode, and wherein the reference electrode is an electrode layer arranged on an ultrathin film that is fabricated from an aluminum alloy. The electrode layer has an electrochemically active lithium compound, a conductive carbon additive, and a polymeric binder that are arranged on the ultrathin film that is fabricated from the aluminum alloy.

Another aspect of the disclosure includes the ultrathin film that is fabricated from an aluminum alloy having a modulus of elasticity that is within a range of 20-200 GPa.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows an exploded isometric view of a prismatic battery cell that includes an anode, a cathode, and a reference electrode that are arranged in a stack, in accordance with the disclosure.

FIG. 2 schematically illustrates an isometric view of a portion of an embodiment of an anode, a cathode, and a reference electrode that are arranged in a stack, in accordance with the disclosure.

FIG. 3 schematically illustrates an exploded isometric view of a circular disk-shaped battery cell that includes an anode, a cathode, and a reference electrode that are arranged in a stack, in accordance with the disclosure.

The appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments can be practiced without some of these details. Moreover, for the purpose of clarity, certain technical material that is understood in the related art has not been described in detail to avoid unnecessarily obscuring the disclosure. Furthermore, the drawings are in simplified form and are not to precise scale. For purposes of convenience and clarity only, directional terms such as top, bottom, left, right, up, over, above, below, beneath, rear, and front, may be employed to assist in describing the drawings. These and similar directional terms are illustrative, and are not to be construed to limit the scope of the disclosure. Furthermore, the disclosure, as illustrated and described herein, may be practiced in the absence of an element that is not specifically disclosed herein.

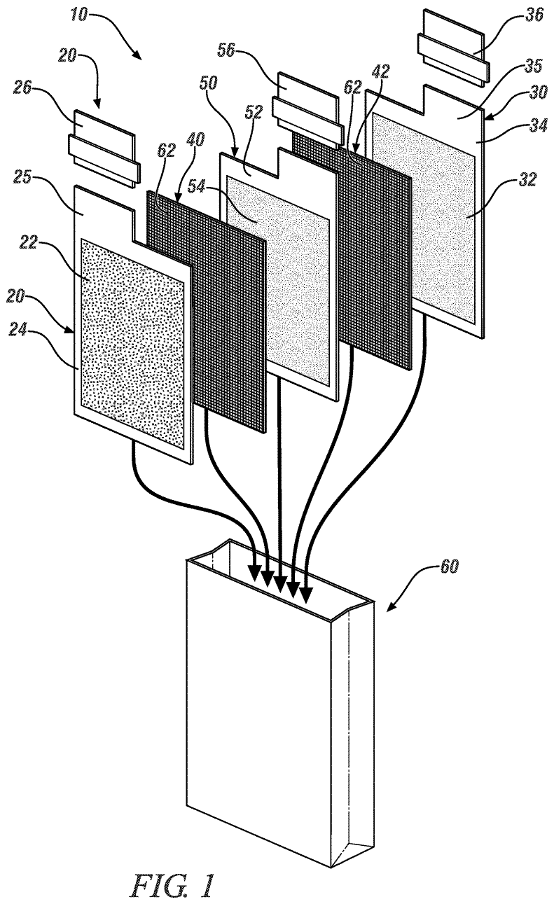

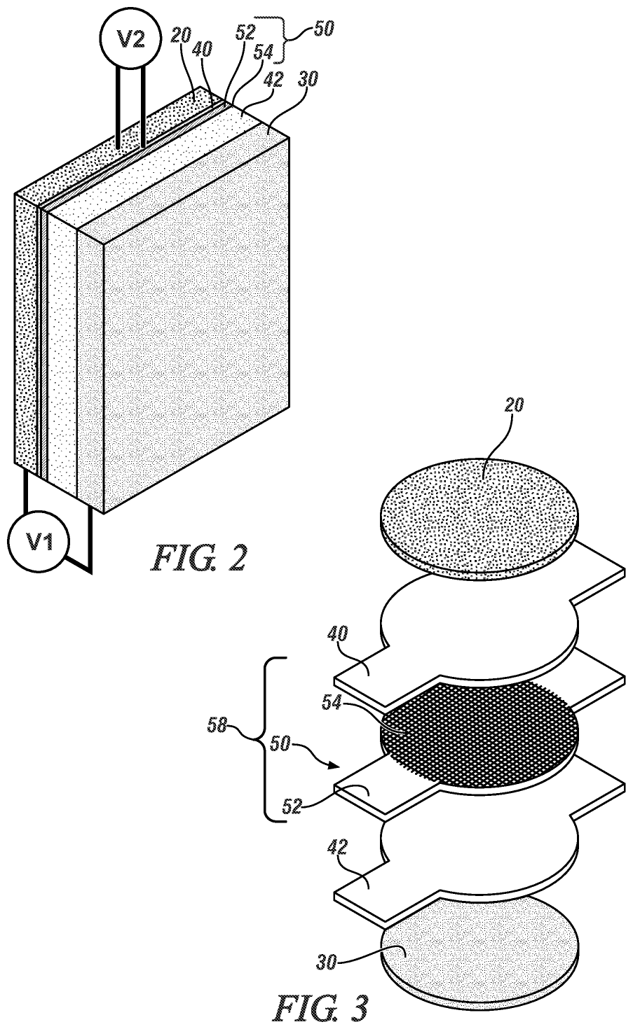

Referring to the drawings, wherein like reference numerals correspond to like or similar components throughout the several Figures, FIGS. 1 and 2 schematically illustrate an embodiment of a prismatically-shaped lithium ion battery cell 10 that includes an anode 20, a first separator 40, a reference electrode 50, a second separator 42, and a cathode 30 that are arranged in a stack and sealed in a flexible pouch 60 containing an electrolytic material 62. A first, negative battery cell tab 26 and a second, positive battery cell tab 36 protrude from the flexible pouch 60. The terms “anode” and “negative electrode” are used interchangeably. The terms “cathode” and “positive electrode” are used interchangeably. A single arrangement of the anode 20, first separator 40, reference electrode 50, second separator 42, and cathode 30 is illustrated. It is appreciated that multiple arrangements of the anode 20, first separator 40, reference electrode 50, second separator 42, and cathode 30 may be arranged and electrically connected in the flexible pouch 60, depending upon the specific application of the battery cell 10.

The anode 20 includes a first active material 22 that is arranged on an anode current collector 24. The anode current collector 24 has a foil portion 25 that extends from the first active material 22 to form the first battery cell tab 26.

The cathode 30 includes a second active material 32 that is arranged on a cathode current collector 34, with the cathode current collector 34 having a foil portion 35 that extends from the second active material 32 to form the second battery cell tab 36.

The reference electrode 50 includes an ultrathin porous aluminum current collector 52 that is coated on one side with a porous active material layer 54. The reference electrode 50 provides a fixed and unchanging electrochemical potential relative to other electrodes in the cell. The porous active material layer 54 is an electrochemically active lithium-intercalating compound such as lithium iron phosphate or lithium titanate that exhibits a constant or nearly constant potential over a broad range of lithium contents. Additionally, the porous active material layer 54 may contain a conductive carbon diluent and a polymeric binder. An independent electrical path through the cell pouch to the reference electrode is provided in the form of the reference electrode tab 56.

The first separator 40 is arranged between the positive electrode 30 and the reference electrode 50 to physically separate and electrically isolate the positive electrode 30 from the reference electrode 50.

The second separator 42 is arranged between the negative electrode 20 and the reference electrode 50 to physically separate and electrically isolate the negative electrode 20 from the reference electrode 50.

In one embodiment, the first separator 40, the reference electrode 50, and the second separator 42 are fabricated as a single, unitary element 58 that can be interposed between the anode 20 and the cathode 30, thus simplifying the assembly and improving the manufacturability of the battery cell 10.

The electrolytic material 62 that conducts lithium ions is contained within the separator 40 and is exposed to each of the positive and negative electrodes 30, 20 to permit lithium ions to move between the positive and negative electrodes 30, 20. Lithium ions de-intercalated from the negative electrode 20 during discharge or from the positive electrode 30 during charge give up electrons that flow through the current collectors 24 and 34, respectively, through an external circuit connected either to a load or a charger, and then to the opposite current collectors (34 and 24) and electrodes (30 and 20) where they reduce lithium ions as they are being intercalated.

The negative electrode 20 and the positive electrode 30 are fabricated as electrode material that is able to intercalate and deintercalate lithium ions. The electrode materials of the positive and negative electrodes 30, 20 are formulated to store intercalated lithium at different electrochemical potentials relative to a common reference electrode, e.g., lithium. In the construct of the electrode pair 20, the negative electrode 20 stores intercalated lithium at a lower electrochemical potential (i.e., a higher energy state) than the positive electrode 30 such that an electrochemical potential difference exists between the positive and negative electrodes 30, 20 when the negative electrode 20 is lithiated. The electrochemical potential difference for each battery cell 10 results in a charging voltage in the range of 3V to 5V and nominal open circuit voltage in the range of 2.9V to 4.2V. These attributes of the negative and positive electrodes 30, 20 permit the reversible transfer of lithium ions between the positive and negative electrodes 30, 20 either spontaneously (discharge phase) or through the application of an external voltage (charge phase) during operational cycling of the electrode pair 20. The thickness of each positive and negative electrode 30, 20 ranges between 30 microns (um) and 150 um.

The negative electrode 20 is a lithium host material such as, for example, graphite, silicon, or lithium titanate. The lithium host material may be intermingled with a polymeric binder material to provide the negative electrode 20 with structural integrity and, in one embodiment, a conductive fine particle diluent. The lithium host material is preferably graphite and the polymeric binder material is preferably one or more of polyvinylidene fluoride (PVdF), an ethylene propylene diene monomer (EPDM) rubber, styrene butadiene rubber (SBR), a carboxymethyl cellulose (CMC), polyacrylic acid, or mixtures thereof. Graphite is normally used to make the negative electrode 20 because, in addition to being relatively inert, its layered structure exhibits favorable lithium intercalation and deintercalation characteristics that help provide the battery electrode pair 20 with a desired energy density. Various forms of graphite that may be used to construct the negative electrode 20 are commercially available. The conductive diluent may be very fine particles of, for example, high-surface area carbon black.

The positive electrode 30 is composed as a lithium-based active material that stores intercalated lithium at a higher electrochemical potential (relative to a common reference electrode) than the lithium host material used to make the negative electrode 20. The same polymeric binder materials (PVdF, EPDM, SBR, CMC, polyacrylic acid) and conductive fine particle diluent (high-surface area carbon black) that may be used to construct the negative electrode 20 may also be intermingled with the lithium-based active material of the positive electrode 30 for the same purposes. The lithium-based active material is preferably a layered lithium transition metal oxide, such as lithium cobalt oxide, a spinel lithium transition metal oxide, such as spinel lithium manganese oxide, a lithium polyanion, such as a nickel-manganese-cobalt oxide, lithium iron phosphate, or lithium fluorophosphate. Some other suitable lithium-based active materials that may be employed as the lithium-based active material include lithium nickel oxide, lithium aluminum manganese oxide, and lithium vanadium oxide, to name examples of alternatives. Mixtures that include one or more of these recited lithium-based active materials may also be used to make the positive electrode 30.

The first and second separators 40, 42 are each composed as one or more porous polymer layers that, individually, may be composed of any of a wide variety of polymers. Only one such polymer layer is shown here for simplicity. Each of the one or more polymer layers may be a polyolefin. Some specific examples of a polyolefin are polyethylene (PE) (along with variations such as HDPE, LDPE, LLDPE, and UHMWPE), polypropylene (PP), or a blend of PE and PP. The polymer layer(s) function to electrically insulate and physically separate the negative and positive electrodes 20, 30 from the reference electrode 50. The first and second separators 40, 42 may further be infiltrated with a liquid electrolyte throughout the porosity of the polymer layer(s). The liquid electrolyte, which also wets both electrodes 20, 30, preferably includes a lithium salt dissolved in a non-aqueous solvent.

The first and second separators 40, 42 have thicknesses that may be between 10 microns (um) to 50 um.

The descriptions set forth above pertaining to the negative electrode 20, the positive electrode 30, the first and second separators 40, 42, and the electrolytic material 62 are intended to be non-limiting examples. Many variations on the chemistry of each of these elements may be applied in the context of the lithium ion battery cell 10 of the present disclosure. For example, the lithium host material of the negative electrode 20 and lithium-based active material of the positive electrode 30 may be compositions other than those specific electrode materials listed above, particularly as lithium ion battery electrode materials continue to be researched and developed. Additionally, the polymer layer(s) and/or the electrolyte contained within the polymer layer(s) of the first and second separators 40, 42 may also include other polymers and electrolytes than those specifically listed above. In one variation, the first and second separators 40, 42 may be a solid polymer electrolyte that includes a polymer layer—such as polyethylene oxide (PEO), polypropylene oxide (PPO), polyacrylonitrile (PAN), or polyvinylidene fluoride (PVdF) having a lithium salt or swollen with a lithium salt solution. The anode 20 and cathode 30 reversibly exchange lithium ions through the first and second separators 40, 42 and the reference electrode 50 during applicable discharge and charge cycles.

The anode and cathode current collectors 24, 34 are thin metallic plate-shaped elements that contact their respective first and second active materials 22, 32 over an appreciable interfacial surface area. The purpose of the anode and cathode current collectors 24, 34 is to exchange free electrons with their respective first and second active materials 22, 32 during discharging and charging.

The cathode current collector 34 is a planar sheet that is fabricated from aluminum or an aluminum alloy, and has a thickness at or near 0.02 mm. The reference electrode 50 that is interposed between the anode 20 and the cathode 30 includes an electrode layer 54 that is arranged on a current collector 52 having a tab portion 56 that projects out of the pouch 60 for electrical connection. The current collector 52 is arranged as both a mechanical support for the electrode layer and a means for conducting electrons to and from the electrode layer. The reference electrode 50 includes the electrode layer 54 arranged on the current collector 52, wherein the electrode layer 54 has an electrochemically active lithium compound, a conductive carbon additive, and a polymeric binder, arranged on the current collector 52, and wherein the current collector 52 is fabricated from an aluminum alloy.

The current collector 52 is fabricated from pure aluminum, or alternatively, an aluminum alloy. When the current collector 52 is fabricated from an aluminum alloy, the aluminum alloy has an aluminum content that is greater than 90%, and an alloy that includes one or a combination of copper, zinc, silver, gold, titanium, magnesium, silicon, manganese, cobalt, iron, chrome, and/or rare earth metals. The aluminum or aluminum alloy material for the current collector 52 has a modulus of elasticity that is within a range of 20-200 GPa (gigapascals). The value for the modulus of elasticity is selected to withstand physical mechanical expansions and contractions in the battery cell 10 due to temperature variations and mechanical tensions, twistings, etc. that may occur over the service life of the battery cell 10.

The aluminum alloy for the current collector 52 is fabricated to have a porosity that is in a range between 20% and 80% in one embodiment, and with a target range between 30% and 60%.

The current collector 52 for the reference electrode 50 has a thickness that is less than 50 um in one embodiment. The current collector 52 for the reference electrode 50 is an ultrathin film that has a thickness that is between 5 um and 50 um in one embodiment, and is coated on one side with the porous active material layer 54. The ultrathin film of the current collector 52 is fabricated from an aluminum alloy in one embodiment. As used herein, “thin” in certain embodiments refers to a thickness of less than about 100-200 microns, and “ultrathin” refers to a thickness that is less than 50 microns and as thin as 5 microns.

The concepts described herein provide for a battery cell having a reference electrode that has a porous aluminum ultrathin film as a current collector. The aluminum layer is conductive and works as the current collector for the reference electrode. The thickness of the aluminum layer can be between 5-50 um. The porosity of the aluminum layer can be within 20% and 80%, preferably 30-60%. The reference material is coated on the porous Al layer. The aluminum layer can be made by high pure aluminum or by aluminum alloy with aluminum content that is greater than 90%. The alloying elements may include but not limited to one or more of the following, copper, zinc, silver, gold, titanium, chrome, rare earth etc. to achieve the best balance between electrical, mechanical and chemical properties. This concept enables the large-scale mass manufacturing of battery cells having reference electrodes by reducing material cost and reducing manufacturing complexity, as compared to known reference electrodes that employ gold, silver, or one of the platinum-group metals.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. An electrochemical battery cell, comprising:
an anode, a cathode, and a reference electrode;
wherein the reference electrode is interposed between the anode and the cathode;
wherein the reference electrode is an electrode layer arranged on a current collector;
wherein the electrode layer has an electrochemically active lithium compound, a conductive carbon additive, and a polymeric binder that are arranged on the current collector; and
wherein the current collector is fabricated from an aluminum alloy.

2. The electrochemical battery cell of claim 1, further comprising a first separator interposed between the anode and the reference electrode, and a second separator interposed between the reference electrode and the cathode.

3. The electrochemical battery cell of claim 2, wherein the first separator, the reference electrode, and the second separator are fabricated as a single element that is interposed between the anode and the cathode.

4. The electrochemical battery cell of claim 1, wherein the reference electrode comprises a porous active material layer that is arranged on the current collector.

5. The electrochemical battery cell of claim 1, wherein the current collector for the reference electrode has a thickness that is between 5 microns (um) and 50 um.

6. The electrochemical battery cell of claim 1, wherein the current collector is fabricated from an aluminum alloy having a porosity that is in a range between 30% and 60%.

7. The electrochemical battery cell of claim 1, wherein the current collector is fabricated from an aluminum alloy having a porosity that is in a range between 20% and 80%.

8. The electrochemical battery cell of claim 1, wherein the current collector is fabricated from an aluminum alloy having an aluminum content that is greater than 90%.

9. The electrochemical battery cell of claim 1, wherein the current collector is fabricated from an aluminum alloy having an aluminum content that is greater than 90%, and an alloy comprising one of copper, zinc, silver, gold, titanium, or chrome.

10. The electrochemical battery cell of claim 9, wherein the aluminum alloy has a modulus of elasticity that is within a range of 20 to 200 GPa (gigapascals).

11. The electrochemical battery cell of claim 1, wherein the current collector is arranged as a rectangular planar sheet.

12. The electrochemical battery cell of claim 1, wherein the current collector is arranged as a circular planar sheet.

13. The electrochemical battery cell of claim 1, wherein the current collector is arranged as a cylindrical sheet.

14. An electrochemical battery cell, comprising:
an anode, a cathode, a reference electrode, a first separator, and a second separator;
wherein the reference electrode is interposed between the anode and the cathode;
wherein the first separator is interposed between the anode and the reference electrode;
wherein the second separator is interposed between the reference electrode and the cathode; and
wherein the reference electrode has an electrochemically active lithium compound, a conductive carbon additive, and a polymeric binder that are arranged on an ultrathin film that is fabricated from an aluminum alloy.

15. The electrochemical battery cell of claim 14, wherein the first separator, the reference electrode, and the second separator are fabricated as a single element that is interposed between the anode and the cathode.

16. The electrochemical battery cell of claim 14, wherein the ultrathin film is fabricated from an aluminum alloy and has a thickness that is between 5 microns (um) and 50 um.

17. The electrochemical battery cell of claim 14, wherein the ultrathin film is fabricated from an aluminum alloy and has a porosity that is between 30% and 60%.

18. The electrochemical battery cell of claim 14, wherein the ultrathin film is fabricated from an aluminum alloy and has a modulus of elasticity that is within a range of 20 to 200 GPa (gigapascals).

19. The electrochemical battery cell of claim 14, wherein the ultrathin film is fabricated from an aluminum alloy having an aluminum content that is greater than 90%, and an alloy comprising one of copper, zinc, silver, gold, titanium, or chrome.

20. The electrochemical battery cell of claim 14, wherein the ultrathin film is fabricated from pure aluminum.
